(19) United States
(12) Patent Application Publication
(10) Pub. No.: US 2006/0200310 A1
(43) Pub. Date: Sep. 7, 2006

(54) Personal Navigation System and route guiding method in the personal navigation system

(75) Inventors: Jong-Hyun Kim, Suwon-si (KR); Suk-In Jung, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/366,669

(22) Filed: Mar. 2, 2006

(30) Foreign Application Priority Data
Mar. 2, 2005 (KR) 2005-17449

(51) Int. Cl. G01C 21/34

(52) U.S. Cl. 701/209; 701/202; 340/995.19

(57) ABSTRACT

A Personal Navigation System (PNS) and a route guiding method in the PNS are provided. The PNS includes a mobile terminal for transmitting a route guiding request message including its current position information and destination information in response to a route guiding request from a user and a personal navigation server for receiving the route guiding request message, determining the accuracy of the current position information included in the received route guiding request message, providing Route Guiding Information (RGI) according to the current position information and the destination information if the current position information has a high accuracy, and providing destination coordinate information and peripheral map information around a user's current position to provide a direction toward a user's destination if the current position information has a low accuracy. Thus, when initial position of a user is inaccurate, route guiding using the inaccurate initial position is deferred and the user is guided in a direction toward a destination, thereby preventing additional deviation from a correct route due to inaccurate route guiding.

### PRIORITY

This application claims priority under 35 U.S.C. § 119 to an application entitled “Personal Navigation System and Route Guiding Method in the Personal Navigation System” filed in the Korean Intellectual Property Office on Mar. 2, 2005 and assigned Ser. No. 2005-17449, the entire contents of which are incorporated herein by reference.

### BACKGROUND OF THE INVENTION

1. Field of the Invention

The present invention generally relates to a Personal Navigation System (PNS), and in particular, to a PNS and a route guiding method in the PNS to guide a person walking in a direction toward a destination when it is impossible to accurately guide a route to the destination due to an inaccurate current position of the walker.

2. Description of the Related Art

Generally, a Personal Navigation System (PNS) refers to a system for providing position/geographic information services to individuals through mobile terminals such as Personal Digital Assistants (PDA) or mobile phones. The PNS includes a mobile terminal and a personal navigation server for providing geographic information to the mobile terminal.

The PNS can generally provide position/geographic information services to a mobile terminal of a person walking on a narrow footpath or an alley as well as a mobile terminal in a vehicle moving on a roadway. In the PNS, the mobile terminal recognizes the current position of a user, receives a user's desired destination, and transmits a request for a route to the destination to the personal navigation server using the current position and the destination.

The personal navigation server calculates a route from the current position to the destination at the request of the mobile terminal and provides the resulting Route Guiding Information (RGI) to the mobile terminal. The mobile terminal then provides a route to the destination in the form of screen information and voice information while displaying a map for a corresponding area around the current position.

In the PNS, the mobile terminal receives a Global Positioning System (GPS) signal from a GPS satellite to measure its position, i.e., a user's position using the received GPS signal, and the personal navigation server generates RGI based on the measured user's position.

However, in areas where the GPS signal is not received well or not at all or in a case of the GPS signal having a large error due to the terminal's surroundings such as high buildings, the mobile terminal cannot acquire an accurate current position of the user and requests route guiding with the inaccurate current position. The personal navigation system will generate wrong RGI with the inaccurate current position of the user and provides the wrong RGI to the user.

A conventional PNS continues providing inaccurate route guiding until the accurate current position of the user is acquired. Upon acquisition of the accurate current position, the PNS generates accurate RGI and provides accurate route guiding. As a result, the user cannot recognize that an inaccurate route has been provided until the accurate current position is acquired and the user may move according to inaccurate route guiding, resulting in deviation from a correct route.

Conventionally, when the user deviates from the accurate route due to the inaccurate current position, the mobile terminal re-requests route guiding and the personal navigation server re-calculates a route to the destination from the deviated position, thereby providing accurate RGI.

However, the conventional PNS requires an additional route guiding request and additional route calculation processes, and thus a delay occurs in providing a service due to such additional processes, causing inconvenience to users.

### SUMMARY OF THE INVENTION

It is, therefore, an object of the present invention to provide a Personal Navigation System (PNS) and a route guiding method in the PNS, in which route guiding using an inaccurate current position of a user is deferred and the user is guided in a direction toward a user's destination.

It is another object of the present invention to provide a PNS and a route guiding method in the PNS, in which a user is guided in a direction toward a user's destination in a case where a user's current position is inaccurate, and accurate Route Guiding Information (RGI) is provided to the user upon acquisition of an accurate current position of the user.

According to one aspect of the present invention, there is provided a Personal Navigation System (PNS). The PNS includes a mobile terminal for transmitting a route guiding request message including its current position information and destination information in response to a route guiding request from a user and a personal navigation server for receiving the route guiding request message, determining the accuracy of the current position information included in the received route guiding request message, providing Route Guiding Information (RGI) according to the current position information and the destination information if the current position information has a high accuracy, and providing destination coordinate information and peripheral map information around a user's current position to provide a direction toward a user's destination if the current position information has a low accuracy.

According to another aspect of the present invention, there is provided a route guiding method in a Personal Navigation System (PNS). The route guiding method includes a mobile terminal transmitting a route guiding request message to a personal navigation server in response to a route guiding request from a user, the personal navigation server determining the accuracy of the current position information included in the route guiding request message, the personal navigation server providing Route Guiding Information (RGI) according to the current position information and the destination information if the current position information has a high accuracy and providing destination coordinate information and peripheral map information around a user's current position if the current position information has a low accuracy, and the mobile terminal performing route guiding if the RGI is provided and guiding the user in a direction toward a user's destination if the destination coordinate information and the peripheral map information are provided.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 illustrates a Personal Navigation System (PNS) according to the present invention;

FIG. 2 is a block diagram of a mobile terminal according to the present invention;

FIG. 3 is a block diagram of a personal navigation server according to the present invention;

FIG. 4 is a flowchart illustrating the operation of a mobile terminal for route guiding according to the present invention;

FIG. 5 illustrates the structure of a route guiding request message according to a first embodiment of the present invention;

FIG. 6 illustrates a route guiding screen according to the present invention;

FIG. 7 illustrates the structure of a route guiding request message according to a second embodiment of the present invention; and

FIG. 8 is a flowchart of the operation of a personal navigation server for route guiding according to the present invention.

### DETAILED DESCRIPTION OF THE PREFERRED EMBODIMENT

The matters defined in the description such as a detailed construction and elements are provided to assist in a comprehensive understanding of the exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

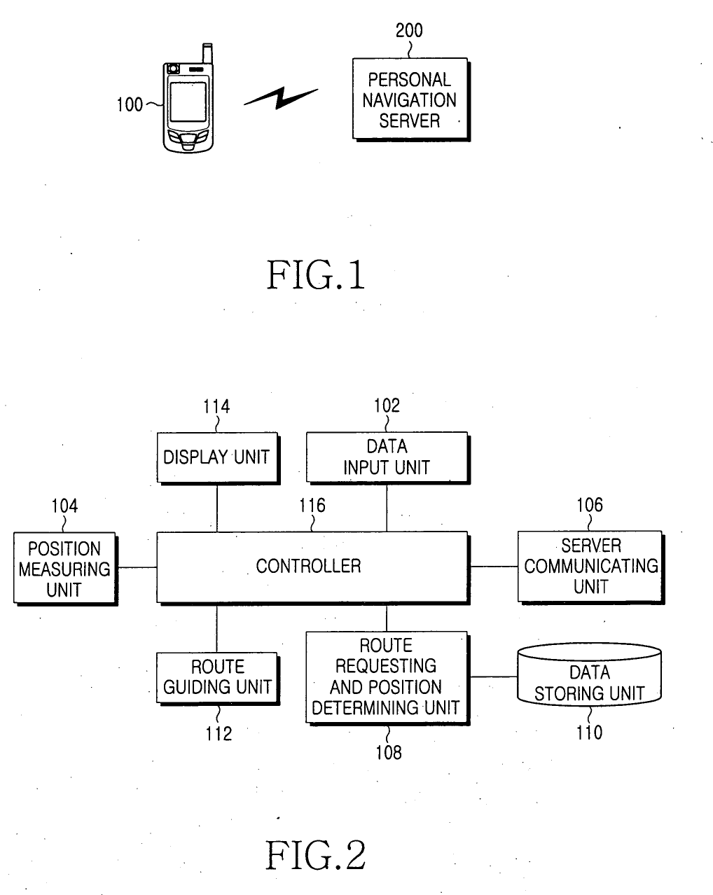

FIG. 1 illustrates a Personal Navigation System (PNS) according to the present invention. Referring to FIG. 1, the PNS includes a mobile terminal 100 and a personal navigation server 200.

Upon input of a destination according to a route guiding request from a user, the mobile terminal 100 measures its (user's) initial position using a received Global Positioning System (GPS) signal and transmits a route guiding request message including the destination and the initial position to the personal navigation server 200. The mobile terminal 100 performs route guiding according to Route Guiding Information (RGI) provided from the personal navigation server 200 when the initial position is accurate. When the initial position is not accurate, the mobile terminal 100 guides the user in a direction toward the destination based on destination coordinate information, peripheral network information around the mobile terminal 100, and screen display information that are provided from the personal navigation server 200. When guiding the user in a direction toward the destination, the mobile terminal 100 stores and analyzes a user's moving trace to check if the user's position is matched with the peripheral network information. If the user's position is matched with the peripheral network information, the mobile terminal 100 transmits a route guiding request message including matched link information and the destination to the personal navigation server 200.

The personal navigation server 200 receives the route guiding request message including the user's current position and the destination from the mobile terminal 100 and determines whether the user's current position included in the received route guiding request message is initial position information acquired using the GPS signal or link information. If the user's current position included in the received route guiding request message is the link information, the personal navigation server 200 generates route guiding information using the link information and destination information and provides the same to the mobile terminal 100. If the user's current position included in the received route guiding request message is the initial position information acquired using the GPS signal, the personal navigation server 200 determines the accuracy of the user's current position. If the user's current position has a high accuracy, the personal navigation server 200 generates Route Guiding Information (RGI) according to the initial position information and the destination information and provides the same to the mobile terminal 100. If the user's current position has a low accuracy, the personal navigation server 200 defers generation of RGI and provides the destination coordinate information, the peripheral network information, and the screen display information to the mobile terminal 100.

In other words, the PNS structured as described above defers route guiding in the case where the user's current position is inaccurate, guides the user in a direction toward the destination, and provides accurate route guiding upon acquisition of an accurate user's position.

Hereinafter, the configuration of the mobile terminal 100 and the configuration of the personal navigation server 200 will be described in more detail.

FIG. 2 is a block diagram of the mobile terminal 100 according to the present invention. Referring to FIG. 2, the mobile terminal 100 includes a data input unit 102, a position measuring unit 104, a server communicating unit 106, a route requesting and position determining unit 108, a data storing unit 110, a route calculating unit 112, a display unit 114, and a controller 116.

The data input unit 102 may be an input device such as a keypad or a touch panel and receives data input from a user. For example, the data input unit 102 receives a route guiding request, e.g., a destination from the user, according to the present invention.

The position measuring unit 104 measures the position of the mobile terminal, i.e., a user's position, using a GPS signal received from a GPS satellite.

The server communicating unit 106 performs communication interfacing between the mobile terminal 100 and the personal navigation server 200. For example, the server communicating unit 106 transmits a route guiding request message to the personal navigation server 200 and receives RGI or destination coordinate information and peripheral map information from the personal navigation server 200 as a response to the route guiding request message.

The route requesting and position determining unit 108 generates a route guiding request message using the destination input from the user and the user's position measured by the position measuring unit 104. If RGI is received as a response to the route guiding request message, the route requesting and position determining unit 108 sets information for route guiding according to the received RGI. If the destination coordinate information and the peripheral map information are received as a response to the route guiding request message, the route requesting and position determining unit 108 collects user moving trace information and compares link information of the received peripheral map information and the received user moving trace information to detect matched link information, thereby determining the user's accurate current position.

The data storing unit 110 temporarily stores the user moving trace information collected by the route requesting and position determining unit 108 and the peripheral map information received from the personal navigation server 200.

The route guiding unit 112 provides a route to the user based on route information set by the route requesting and position determining unit 108. The display unit 114 outputs screen data for route guiding.

The controller 116 controls an overall operation of the mobile terminal 100 and controls a data flow between components of the mobile terminal 100.

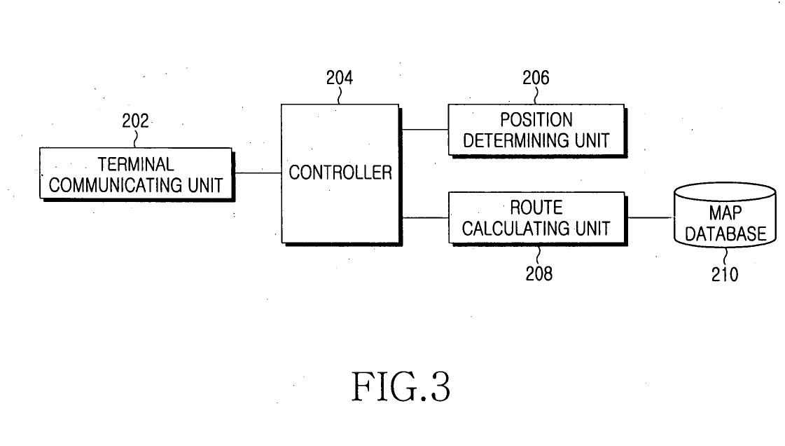

FIG. 3 is a block diagram of the personal navigation server 200 according to the present invention. Referring to FIG. 3, the personal navigation server 200 includes a terminal communicating unit 202, a controller 204, a position determining unit 206, a route calculating unit 208, and a map database 210.

The terminal communicating unit 202 performs communication interfacing between the personal navigation server 200 and the mobile terminal 100. The terminal communicating unit 202 receives the route guiding request message from the mobile terminal 100 and transmits RGI or the destination coordinate information and the peripheral map information to the mobile terminal 100 in response to the route guiding request message.

The position determining unit 206 determines whether the user's current position included in the route guiding request message received from the mobile terminal 100 is the initial position information acquired using the GPS signal or the link information. The position determining unit 206 also determines whether the initial position information included in the route guiding request message or the link information is accurate. If the user's current position included in the route guiding request message is inaccurate, the position determining unit 206 generates the destination coordinate information, the peripheral network information around the current position, and the screen display information. If the user's current position included in the route guiding request message is accurate, the position determining unit 206 transmits route guiding request information to the route calculating unit 208 through the controller 204.

The route calculating unit 208 generates RGI according to the initial position information and the destination information based on the route guiding request information transmitted from the position determining unit 206. In other words, the route calculating unit 208 calculates a route based on the current position of the mobile terminal and the destination provided from the position determining unit 206 using map data stored in the map database 210 and generates RGI according to the calculation result.

The controller 204 controls an overall operation of the personal navigation server 200 and controls a data flow between components of the personal navigation server 200.

The PNS according to the present invention is designed in consideration of hardware because a large amount of map data cannot be stored in the mobile terminal 100. Thus, in an embodiment of the present invention, the personal navigation server 200 stores map data and provides RGI corresponding to the position of the mobile terminal 100 using the stored map data, and the mobile terminal 100 provides a route by downloading the RGI from the personal navigation server 200.

However, if the mobile terminal 100 can be implemented to store a large amount of map data of the PNS, the position determining unit 206, the route calculating unit 208, and the map database 210 of the PNS according to the present invention can be implemented within the mobile terminal 100.

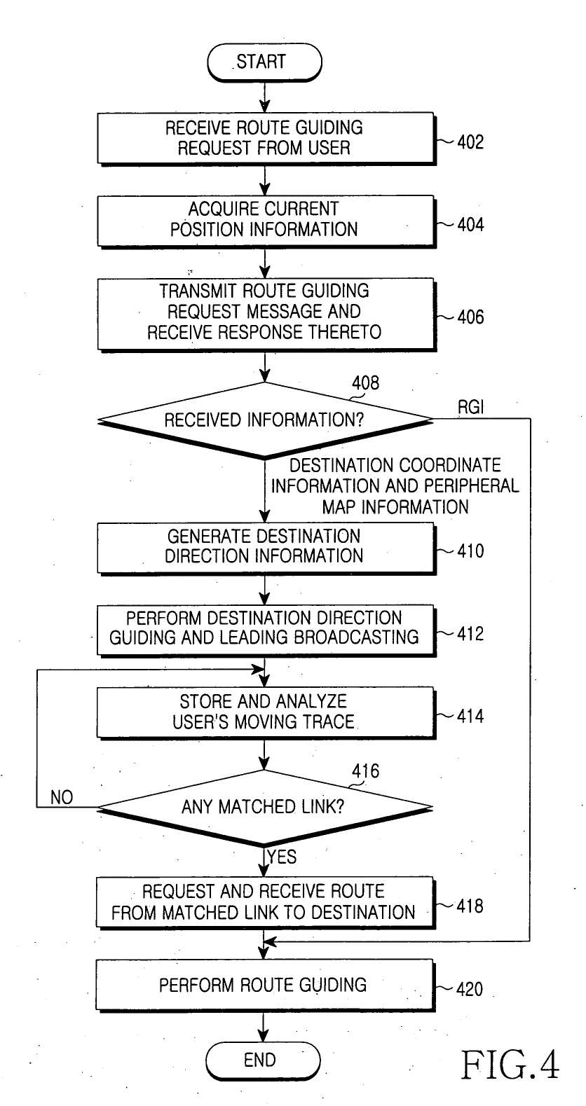

Hereinafter, a route guiding method in the PNS will be described in detail. FIG. 4 is a flowchart illustrating the operation of the mobile terminal 100 for route guiding according to the present invention. Referring to FIG. 4, the mobile terminal 100 receives a route guiding request from a user in step 402. The mobile terminal 100 may receive desired destination information from the user.

Upon input of the route guiding request, the mobile terminal 100 acquires current position information in step 404. The mobile terminal 100 measures its current position using a GPS signal received from a GPS satellite to acquire its current position information.

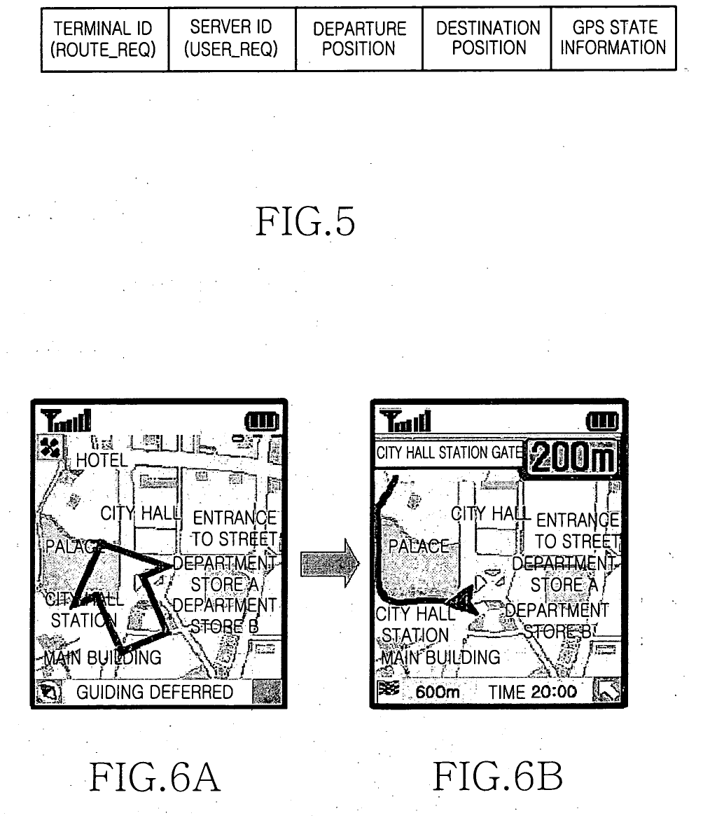

After acquiring current position information, the mobile terminal 100 transmits a route guiding request message to the personal navigation server 200 in step 406 and receives a response to the route guiding request message. Such a route guiding request message is shown in FIG. 5, which illustrates the structure of a route guiding request message according to a first embodiment of the present invention. Referring to FIG. 5, the route guiding request message includes a terminal ID indicating a terminal requesting route guiding, a server ID for requesting route guiding, a departure position of the terminal, a destination position of the terminal, and GPS state information. The departure position of the terminal includes current position information measured using the GPS signal. The destination position of the terminal includes destination position information input by the user. The GPS state information includes the number of received GPS signals or Dilution of Precision (DoP) information. In other words, the mobile terminal 100 generates the route guiding request message as illustrated in FIG. 5 using the destination input from the user and the user's position measured by the position measuring unit 104 and transmits the generated route guiding request message to the personal navigation server 200.

The mobile terminal 100 receives a response to the route guiding request message from the personal navigation server 200 in step 406. The mobile terminal 100 receives RGI as a response to the route guiding request message if the current position information is accurate. If the current position information is inaccurate, the mobile terminal 100 receives destination coordinate information and peripheral map information as a response to the route guiding request message.

When receiving the response to the route guiding request message, the mobile terminal 100 determines whether the received information is RGI or the destination coordinate information and the peripheral map information in step 408. If the received information is the RGI, the mobile terminal 100 goes to step 420 to perform route guiding through the route guiding unit 112.

If the received information is destination coordinate information and peripheral map information, the mobile terminal 100 generates destination direction information in step 410. In other words, if the received information is destination coordinate information and peripheral map information, it means that the current position information is inaccurate. Thus, the mobile terminal 100 defers route guiding and generates direction information toward the destination from the current position using the destination coordinate information received from the personal navigation server 200.

After generating the destination direction information, the mobile terminal 100 performs destination direction guiding and leading broadcasting, such as by means of a voice, in step 412.

Destination direction guiding and leading broadcasting of the mobile terminal 100 is shown in FIG. 6. Referring to FIG. 6A, the mobile terminal 100 displays the generated destination direction information and the peripheral map information on the display unit 114. The mobile terminal 100 outputs voice leading the user in a direction toward the destination, such as “Move along the direction of the arrow to determine an accurate current position” while displaying the destination direction information. Thus, the user can move to the destination based on the destination direction information and leading voice.

When the user moves to the destination according to the destination direction information and leading voice, the mobile terminal 100 recognizes, stores, and analyzes a user's moving trace through the position measuring unit 104 in step 414. In other words, the mobile terminal 100 recognizes user's moving position information through the position measuring unit 104, stores user moving trace information in the data storing unit 110 through the route requesting and position determining unit 108, and analyzes a user's position based on the user moving trace information and the peripheral map information (network information and screen information) received from the personal navigation server 200.

The mobile terminal 100 then determines in step 416 whether there is a link matched with the user's moving trace in the network information received from the personal navigation server 200. If there is no matched link, the mobile terminal 100 returns to step 414 to repeat the storing and analyzing processes until there is a matched link.

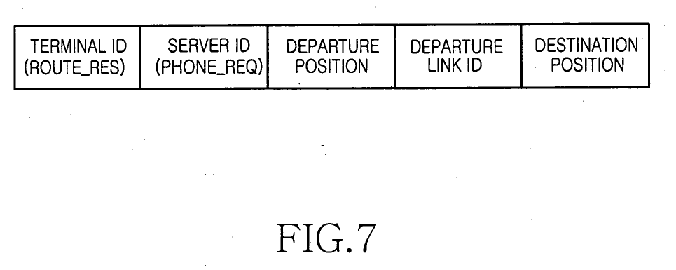

However, if there is a matched link, the mobile terminal 100 generates a route guiding request message for a route from the matched link to the destination in step 418 and transmits the generated route guiding request message to the personal navigation server 200. The route guiding request message for the route from the matched link to the destination is illustrated in FIG. 7, which illustrates the structure of a route guiding request message according to a second embodiment of the present invention. Referring to FIG. 7, the route guiding request message includes a terminal ID indicating a terminal requesting route guiding, a server ID for requesting route guiding, a departure position of the terminal, a departure link ID, and a destination position of the terminal. The departure link ID indicates a link matched with the user's moving trace in the network information received from the personal navigation server 200.

In other words, the mobile terminal 100 generates the route guiding request message as illustrated in FIG. 7 using the destination input from the user and the link ID of the link matched with the user's moving trace and transmits the generated route guiding request message to the personal navigation server 200. The mobile terminal 100 receives a response to the route guiding request message using the link ID from the personal navigation server 200. Because of requesting route guiding using an accurate link ID, the mobile terminal 100 can receive RGI as a response to the route guiding request message.

Upon receipt of RGI, the mobile terminal 100 goes to step 420 to perform route guiding through the route guiding unit 112. For example, the mobile terminal displays destination direction information as in FIG. 6A and outputs voice leading in a direction toward the destination, and, upon receipt of RGI, outputs a route guiding screen using an accurate current position as in FIG. 6B and outputs voice informing accurate route guiding is resumed, such as “Route guiding will start after recognizing current position”.

Thus, the mobile terminal 100 according to the present invention guides the user in a direction toward the destination in the case where the current position is inaccurate and provides accurate RGI upon acquisition of an accurate current position.

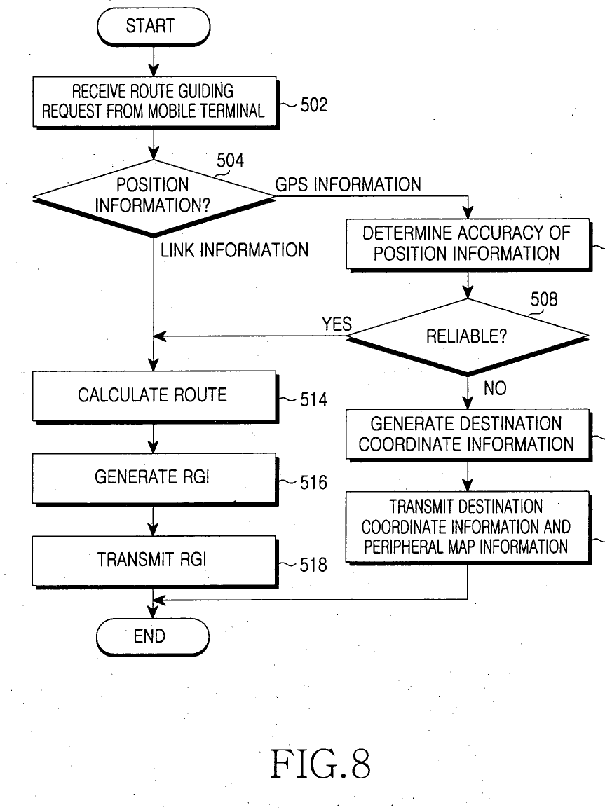

FIG. 8 is a flowchart of the operation of the personal navigation server 200 for route guiding according to the present invention. Referring to FIG. 8, the personal navigation server 200 receives a route guiding request message from the mobile terminal 100 in step 502. Upon receipt of the route guiding request message from the mobile terminal 100, the personal navigation server 200 determines whether the current position information of the mobile terminal 100 included in the received route guiding request message is initial position information acquired using a GPS signal or link information, in step 504.

If the current position information is link information, it means that the mobile terminal 100 recognizes accurate link information of the current position. Thus, the personal navigation server 200 goes to step 514 to calculate a route using the link information and destination information through the route calculating unit 208. The personal navigation server 200 then generates RGI in step 516 and transmits the RGI to the mobile terminal 100 in step 518.

If the current position information is initial position information acquired using a GPS signal, the personal navigation server 200 determines the accuracy of the current position information in step 506. The personal navigation server 200 may determine whether the initial position information acquired using a GPS signal is accurate by checking for GPS state information included in the route guiding request message, i.e., the number of received GPS signals and DoP information.

The personal navigation server 200 can determine whether the initial position information acquired using a GPS signal is accurate using a result of matching the current position information with a map. In other words, the personal navigation server 200 matches the current position information included in the received route guiding request message to the map database 210 to determine the accuracy of the current position information. The personal navigation server 200 may perform map matching based on criteria such as determination of a probability with respect to a correlation between a moving direction and a road azimuth, determination of a probability with respect to a correlation between an estimated position and a distance to a road, and determination of a probability with respect to a moving trace and the geometric shape of the road. The personal navigation server 200 may search in map data for a link corresponding to user position information through map matching and determine an appropriate link, i.e., a road using criterion values determined differently from the above description.

The personal navigation server 200 determines whether the current position information is reliable in step 508. If the current position information has a high accuracy, the personal navigation server 200 determines that the current position information is reliable and goes to step 514 to perform steps 514 through 518.

If the current position information has a low accuracy, the personal navigation server 200 defers route calculation of the route calculating unit 208 and generates destination coordinate information with respect to the current position using the given position information and the map data stored in the map database 210 in step 510.

The personal navigation server 200 transmits the generated destination coordinate information and peripheral map information (network information and screen information) with respect to at least two roads around the given position of the mobile terminal 100 to the mobile terminal 100 in step 512.

As described above, according to the present invention, in initial route guiding of a PNS, it is possible to prevent inaccurate route guiding that may occur due to an error in position accuracy.

Moreover, when the initial position of a user is inaccurate, route guiding using the inaccurate initial position is deferred and the user is guided in a direction toward a destination, thereby preventing additional deviation from a correct route due to inaccurate route guiding.

Furthermore, a direction toward a destination is provided while a user's accurate current position is recognized, thereby enabling the user to search for a route using destination direction and peripheral map information even when the user is not provided with route guiding.

While the present invention has been shown and described with reference to preferred embodiments thereof, it will be understood by those skilled in the art that various changes in form and details may be made therein without departing from the spirit and scope of the invention.

What is claimed is:

1. A Personal Navigation System (PNS) comprising:
a mobile terminal for transmitting a route guiding request message including its current position information and destination information in response to a route guiding request from a user; and
a personal navigation server for receiving the route guiding request message, determining the accuracy of the current position information included in the received route guiding request message, providing Route Guiding Information (RGI) according to the current position information and the destination information if the current position information has a high accuracy, and providing destination coordinate information and peripheral map information around a user's current position to provide a direction toward a user's destination if the current position information has a low accuracy.

2. The PNS of claim 1, wherein the mobile terminal receives the destination coordinate information and the peripheral map information, displays the direction toward the user's destination from the user's current position, and outputs voice to guide the user in the direction toward the user's destination.

3. The PNS of claim 1, wherein the personal navigation server determines the accuracy of the current position information according to Global Positioning System (GPS) state information if the current position information included in the received route guiding request message is initial position information acquired using a GPS signal.

4. The PNS of claim 3, wherein the GPS state information includes the number of received GPS signals and Dilution of Precision (DoP) information.

5. The PNS of claim 1, wherein the personal navigation server performs map matching using the current position information included in the received route guiding request message and determines the accuracy of the current position information according to the map matching result.

6. The PNS of claim 5, wherein the personal navigation server determines the accuracy of the current position information by performing one of a determination of a probability with respect to a correlation between a moving direction and a road azimuth, a determination of a probability with respect to a correlation between an estimated position and a distance to a road, and a determination of a probability with respect to a moving trace and the geometric shape of the road.

7. The PNS of claim 1, wherein the mobile terminal comprises:
a data input unit for receiving the route guiding request and a destination from the user;
a position measuring unit for measuring its current position using a GPS signal received from a GPS satellite;
a communicating unit for transmitting the route guiding request message including the current position information and the destination information upon receipt of the route guiding request and receiving RGI or the destination coordinate information and the peripheral map information as a response to the route guiding request message;
a route guiding unit for performing route guiding if RGI is received and guiding the user in the direction toward the destination if the destination coordinate information and the peripheral map information are received; and
a route requesting and position determining unit for determining an accurate position of the mobile terminal by comparing the received peripheral map information and a user's moving trace during guidance in the direction toward the destination and generating the route guiding request message with respect to the accurate current position.

8. The PNS of claim 7, further comprising a data storing unit for temporarily storing the user's moving trace collected by the route requesting and position determining unit and the received peripheral map information.

9. The PNS of claim 1, wherein the personal navigation server comprises:
a communicating unit for receiving the route guiding request message from the mobile terminal and transmitting RGI or the destination coordinate information and the peripheral map information to the mobile terminal as a response to the route guiding request message;
a position determining unit for determining whether the current position information included in the received route guiding request message is accurate, generating the destination coordinate information and the peripheral map information around the user's current position if the current position information is inaccurate, and requesting route calculation according to the route guiding request message if the current position information is accurate; and
a route calculating unit for generating RGI according to the current position information and the destination information in response to a request from the position determining unit.

10. A route guiding method in a Personal Navigation System (PNS), the route guiding method comprising the steps of:
a mobile terminal transmitting a route guiding request message to a personal navigation server in response to a route guiding request from a user;
the personal navigation server determining the accuracy of current position information included in the route guiding request message;
the personal navigation server providing Route Guiding Information (RGI) according to the current position information and destination information if the current position information has a high accuracy and providing destination coordinate information and peripheral map information around a user's current position if the current position information has a low accuracy; and
the mobile terminal performing route guiding if RGI is provided and guiding the user in a direction toward a user's destination if the destination coordinate information and the peripheral map information are provided.

11. The route guiding method of claim 10, further comprising the mobile terminal determining an accurate position of the user by comparing the received peripheral map information and a user's moving trace during guidance in the direction toward the destination, and generating the route guiding request message with respect to the accurate current position.

12. The route guiding method of claim 10, wherein the personal navigation server determines the accuracy of the current position information according to Global Positioning System (GPS) state information if the current position information included in the received route guiding request message is initial position information acquired using a GPS signal.

13. The route guiding method of claim 10, wherein the personal navigation server matches the current position information included in the received route guiding request message with map data and determines the accuracy of the current position information according to the map matching result.

14. The route guiding method of claim 10, wherein the peripheral map information includes network information about a network around a user's current position and screen display information.

15. The route guiding method of claim 10, wherein the personal navigation server defers generation of RGI if the current position information has a low accuracy and provides the destination coordinate information and the peripheral map information.

16. The route guiding method of claim 10, wherein the mobile terminal displays a direction toward a user's destination from the user's current position if the destination coordinate information and the peripheral map information are provided and outputs voice to guide the user in the direction toward the user's destination.
